(19) United States
(12) Patent Application Publication
(10) Pub. No.: US 2026/0106172 A1
(43) Pub. Date: Apr. 16, 2026

(54) Current Collector Apparatus

(71) Applicant: Board of Trustees of Michigan State University, East Lansing, MI (US)

(72) Inventors: Chengcheng FANG, Okemos, MI (US); Junxiang LIU, Lansing, MI (US)

(73) Assignee: Board of Trustees of Michigan State University, East Lansing, MI (US)

(21) Appl. No.: 19/421,539

(22) Filed: Dec. 16, 2025

Related U.S. Application Data
(63) Continuation of application No. PCT/US2024/035834, filed on Jun. 27, 2024.
(60) Provisional application No. 63/523,389, filed on Jun. 27, 2023.

(51) Int. Cl. H01M 4/66; H01M 10/0525

(52) U.S. Cl. CPC H01M 4/667; H01M 4/661; H01M 10/0525

(57) ABSTRACT

A current collector apparatus is provided. In one aspect, a current collector includes a first metallic layer, a second metallic layer, and a porous polymeric layer positioned between the first metallic layer and the second metallic layer. In another aspect, a current collector employs a porous polymeric layer including pores and metallic particles disposed therein. The metallic particles electrically connect the first and second metallic layers. Each of a first metallic layer and a second metallic layer has a first average thickness that is about 1 nanometer to about 5 micrometers, a porous polymeric layer has a second average thickness that is about 10 nanometers to about 200 micrometers, and/or the current collector has a third average thickness that is about 12 nanometers to about 210 micrometers.

### CROSS-REFERENCE TO RELATED APPLICATIONS

This application is a continuation of international PCT patent application no. PCT/US2024/035834, filed on Jun. 27, 2024, which claims the benefit of U.S. Provisional Application No. 63/523,389, filed on Jun. 27, 2023. The entire disclosures of the above-mentioned applications are incorporated herein by reference.

### BACKGROUND AND SUMMARY

The present disclosure relates generally to a current collector apparatus for an electrochemical cell and methods of making the current collector apparatus.

Improving cell-level gravimetric and volumetric energy density is desired to achieve high-performance batteries in the rapidly evolving field of energy storage technology. The fast-paced advancement of portable electronic devices, electrical vehicles, electrical planes and aviation devices, and smart grid technology has led to a growing need for high-performance energy storage devices. It is advantageous to increase the energy density of batteries as it directly affects their energy storage capacity in unit weight and volume. Energy storage capacity may impact user experiences such as the mileage per charge for electric vehicles (e.g., a battery having a lower energy storage capacity decreases the mileage per charge for electric vehicles as compared to a battery having a higher energy storage capacity). Significant efforts in enhancing energy density have been made in improving the performance of electrochemically active components such as electrode active materials, and electrolytes, as well as optimizing battery structure and new battery chemistry.

It is advantageous to also consider decreasing the mass of non-electrochemically active components like cell cases, separators, and current collectors to improve cell-level energy storage capacity. One of the key non-electrochemically active components in batteries is the current collector. Current collectors are configured to support active material, such as anode active material and cathode active material and serve as an electrical connection between an electrode and an external circuit.

Conventional current collectors are made of a metal foil, such as a copper or aluminum foil. Conventional current collectors may have a thickness that is greater than or equal to about 6 micrometers (μm). These conventional current collectors possess high mass and cost yet do not contribute to the capacity or energy density of the battery. For example, a conventional copper foil current collector of an anode may have an average specific mass that is greater than or equal to about 5 mg/cm² (e.g., a copper foil current collector having a thickness of about 10 μm has a specific mass of about 8.96 mg/cm²), which is about 8% of the total weight of the battery (e.g., the total weight of the battery without cell cases or housings). In another example, a conventional aluminum foil current collector of a cathode may have an average specific mass that is greater than or equal to about 2.5 mg/cm² (e.g., when the thickness of the aluminum foil current collector is about 10 μm), which is about 7% of the total weight of the battery. In combination, conventional anode and cathode current collectors contribute to about 15% of the weight of a battery pack and limit the battery energy density. Reducing the weight of current collectors to achieve minimum thickness while maintaining desired mechanical, chemical, and thermal characteristics is beneficial in enhancing the energy density of a battery.

Conventional methods for fabricating current collectors include mechanical rolling (e.g., via reversibly hot rolling copper ingots) and/or electrochemical deposition techniques. These methods generate copper current collectors that are thick (e.g. having a thickness that is greater than 6 μm) and heavy (e.g., having an average specific mass that is greater than 5 mg/cm²). Furthermore, carbon-based, MXenes-based and composite current collectors have been fabricated, for example via polymer-assisted metal deposition (PAMD) methods and/or pulsed DC magnetron sputtering. The relatively high cost of fabrication via such methods impedes large-scale production. The challenge remains to find a simple method reducing the thickness of the current collector for mass production of ultra-thin and lightweight current collectors.

In accordance with the present invention, a current collector apparatus is provided. In one aspect, a current collector apparatus includes a first metallic layer, at least a second metallic layer, and a porous polymeric layer positioned between the first metallic layer and the second metallic layer. In another aspect, a current collector employs a porous polymeric layer which includes pores and metallic particles disposed in at least some of the pores. In another aspect, metallic particles disposed in at least some of the pores electrically connect a first metallic layer and a second metallic layer of a current collector apparatus. In yet another aspect, each of a first metallic layer and a second metallic layer of a current collector has a first average thickness that is about 1 nanometer (nm) to about 5 micrometers (μm), a porous polymeric layer has a second average thickness that is about 10 nm to about 200 μm, and/or a third average thickness of the current collector is about 10 nm to about 210 μm.

The present current collector apparatus is advantageous over conventional devices. For example, the present current collector apparatus weighs about 70% less than the conventional foil current collectors having the same thickness. The present current collector may have reduced thickness and weight as compared to conventional foil current collectors. The present current collector apparatus may improve cell-level gravimetric energy by 5-10% without sacrificing volumetric energy density. Furthermore, the present current collector apparatus achieves desired mechanical, chemical, and thermal characteristics.

In accordance with the present invention, a method of making a current collector apparatus is provided. In one aspect of a method of making a current collector includes activating a surface of a porous polymeric substrate. In another aspect, a method of making a current collector includes preparing a solution including a metallic material (e.g., a metallic ion material), a metallic alloy thereof, or a metallic salt thereof. A further aspect of a method of making a current collector includes coating a surface of a porous polymeric substrate with a metallic material, a metallic alloy thereof or metallic salt thereof by electroless deposition. In another aspect, a method of making a current collector includes forming a current collector apparatus.

The simplicity and scalability of the present method of making the present current collector apparatus make it a promising solution for the mass production of ultra-thin and lightweight current collectors. The method of making the present current collector apparatus enhances battery energy density and provides valuable manufacturing insights for developing high-performance batteries. Additional advantages and features of the present system and method will become apparent from the following description and appended claims, taken in conjunction with the associated drawings.

### BRIEF DESCRIPTION OF THE DRAWINGS

FIG. 1 shows elevation and partially exploded perspective views of a battery including the present current collector apparatus;

FIG. 2 is a perspective view of the present current collector apparatus;

FIG. 3 is a cross-sectional view, taken along line 3-3 of FIG. 2, showing the present current collector apparatus;

FIGS. 4A-4E are a series of scanning electron microscope (SEM) and optical images showing a portion of the polymeric layer and present current collector apparatus at varied coating durations and thicknesses (FIGS. 4A-4E);

FIG. 5 is a cross-sectional view, taken along line 5-5 of FIG. 4E, showing the portion of the present current collector apparatus;

FIG. 6 is a graph showing the average specific mass of the present current collector apparatus as compared to a commercial copper foil current collector;

FIG. 7 is another graph showing the average specific mass of the present current collector apparatus;

FIG. 8 is a graph showing the resistivity and conductivity of the present current collector apparatus as compared to a commercial copper foil current collector;

FIG. 9 is a graph showing mechanical tensile-strain properties of the present current collector apparatus;

FIG. 10 is a graph showing X-ray diffraction (XRD) analysis of a metal layer of the present current collector apparatus as compared to a commercial copper foil current collector;

FIG. 11 is a graph showing thermogravimetric analysis (TGA) of the present current collector apparatus as compared to a commercial copper foil current collector;

FIG. 12 is a flowchart of a method of making the present current collector apparatus;

FIG. 13 is a series of diagrammatic views showing the method of making the present current collector apparatus;

FIGS. 14A-G are an exploded perspective view of an exemplary half-cell assembly including the present current collector apparatus (FIG. 14A), and a series of graphs showing electrochemical performance of the exemplary half-cell assembly as compared to a second half-cell assembly including a commercial copper foil current collector (FIG. 14B-G);

FIGS. 15A-E are an exploded perspective view of an exemplary full-cell assembly including the present current collector apparatus (FIG. 15A), and a series of graphs showing electrochemical performance of the exemplary full-cell assembly as compared to a second full-cell assembly including a commercial copper foil current collector (FIGS. 15B-E); and

FIGS. 16A-E are an exploded perspective view of an exemplary anode-free cell assembly including the present current collector apparatus (FIG. 16A), and a series of graphs showing electrochemical performance of the exemplary anode-free cell assembly as compared to a second anode-free cell assembly including a commercial copper foil current collector (FIGS. 16B-E).

### DETAILED DESCRIPTION

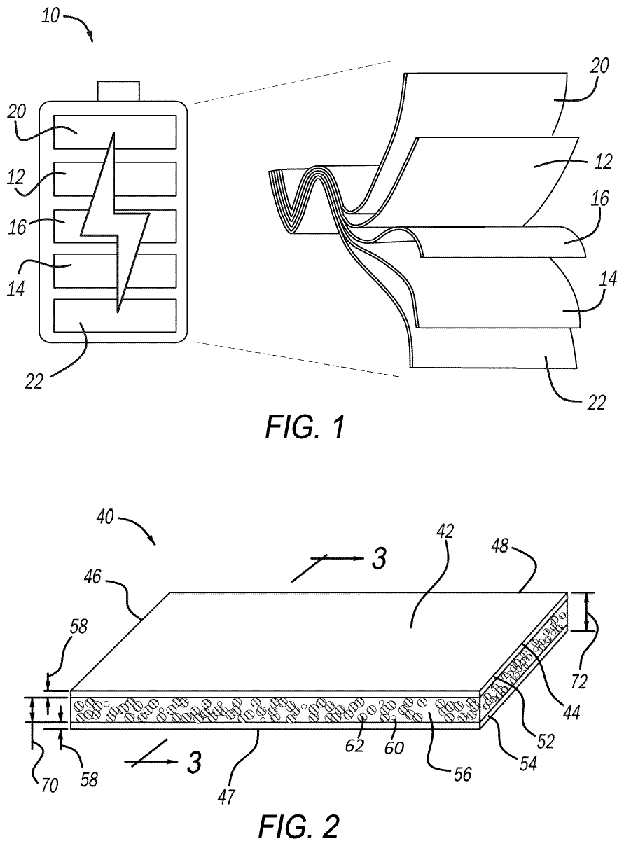

A first embodiment of an electrochemical cell or battery 10 is shown in FIG. 1. The electrochemical cell 10 includes a first electrode 12, such as a positive electrode or cathode, a second electrode 14 such as a negative electrode or anode, a separator 16, and an electrolyte (not shown). The electrochemical cell 10 may be a lithium-ion battery. Alternately, the electrochemical cell 10 may be any other suitable electrochemical energy storage device, such as a lithium-sulfur battery, a sodium-ion battery, an aluminum-ion battery, a manganese-ion battery, a zinc-ion battery, etc. The electrochemical cell 10 may include a single electrode structure of each polarity as shown in FIG. 1. Alternately, a plurality of electrochemical cells 10 may be electrically connected in a stacked structure with a plurality of positive electrodes 12 and negative electrodes 14 assembled in parallel and/or series electrical connections. The electrochemical cell 10 may include various other battery designs such as prismatic shaped cells, wound cylindrical cells, coin cells, pouch cells, or other suitable cell shapes.

Lithium-ion batteries, for example, operate by reversibly passing lithium ions between the negative electrode 14 and the positive electrode 12. The separator 16 and the electrolyte are positioned between the negative electrode 14 and the positive electrode 12. The separator 16 may be a porous separator (e.g., a microporous or nanoporous polymeric separator). The electrolyte is suitable for conducting lithium ions and may be in liquid, gel, or solid form. The electrolyte may be disposed in pores of the porous separator 16. The electrolyte may also be present in the negative electrode 14 and the positive electrode 12, such as in pores. Lithium ions move from the positive electrode 12 to the negative electrode 14 during charging of the electrochemical cell 10, and in the opposite direction when discharging the electrochemical cell 10.

Each of the positive and negative electrodes 12 and 14, respectively, is electrically connected to a current collector. A first or positive electrode current collector 20 is located adjacent and electrically connected to the positive electrode 12. A second or negative electrode current collector 22 is positioned adjacent and electrically connected to the negative electrode 14. The current collectors 20 and 22 collect and move free electrons to and from an external circuit (not shown). The external circuit connects the negative electrode 14 (through the negative electrode current collector 22) and the positive electrode 12 (through the positive electrode current collector 20). During battery usage, the current collectors 20 and 22 associated with the electrodes 12 and 14 are connected by the external circuit allowing current generated by electrons to pass between the negative electrode 14 and the positive electrode 12.

It can be appreciated that the electrochemical cell 10 may include a variety of other components. For example, the electrochemical cell 10 may include a casing, gaskets, terminal caps, tabs, battery terminal, and the like may be situated within the electrochemical cell 10. As noted above, the size and a shape of the electrochemical cell 10 may vary depending on the particular application for which it is designed.

The electrochemical cell 10 has a cell-level energy density (e.g., gravimetric cell-level energy density) or energy storage capacity. As described above, energy density is the amount of energy stored in an electrochemical device per unit volume. It can be appreciated that electrochemical cells having a higher energy density are able to emit larger charge per unit volume. An electrochemical cell having a higher mass has a lower cell-level energy density as compared to a battery having a lower mass. Decreasing the weight of components, such as current collectors, in an electrochemical cell decreases the overall cell mass and therefore improves cell-level energy density.

With reference to FIGS. 1-3, an embodiment of a current collector apparatus 40 is a negative electrode current collector (e.g., the negative electrode current collector 22) or a positive electrode current collector (e.g., the positive electrode current collector 20). The current collector 40 is electrically conductive.

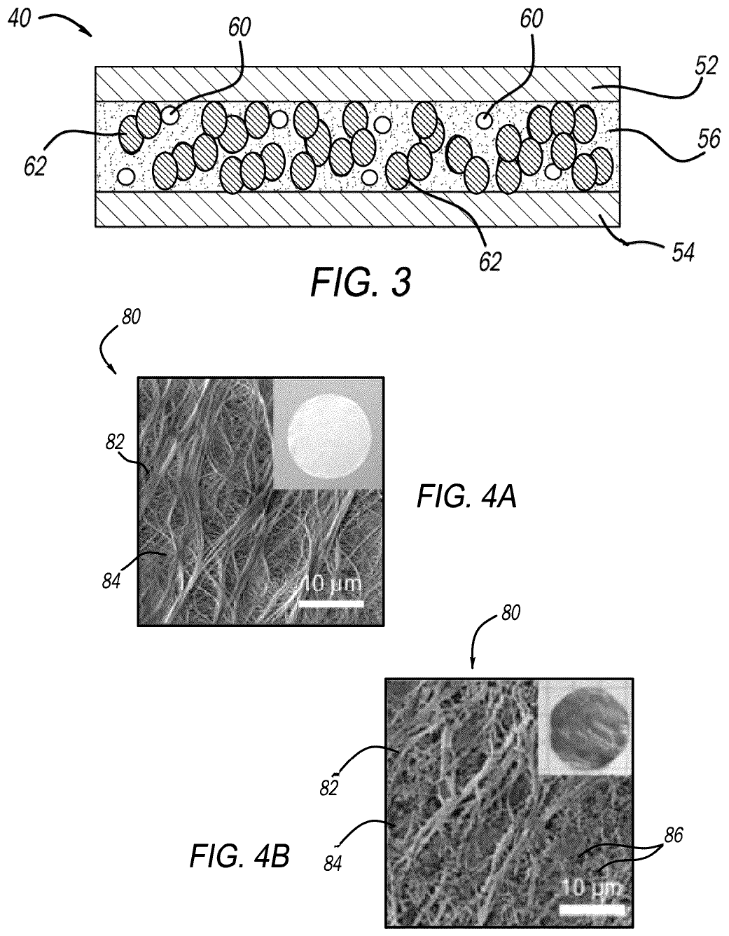

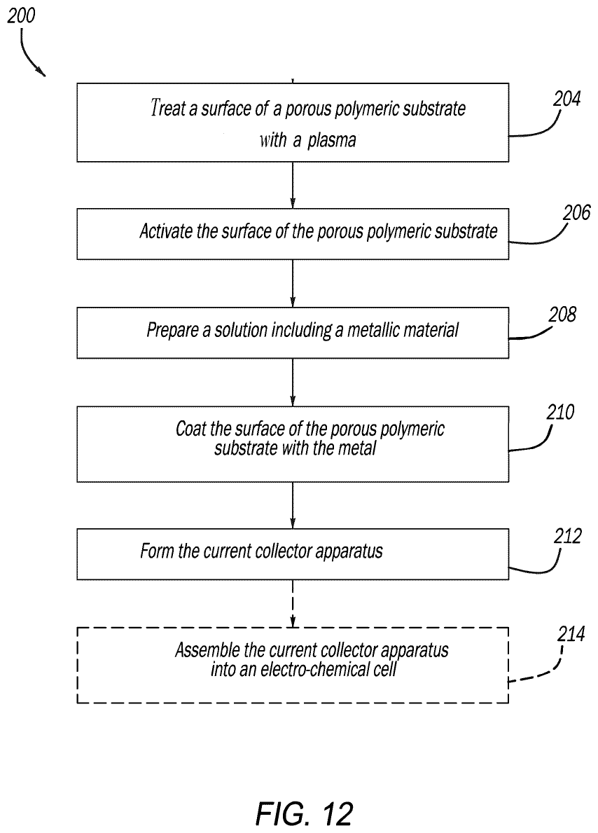

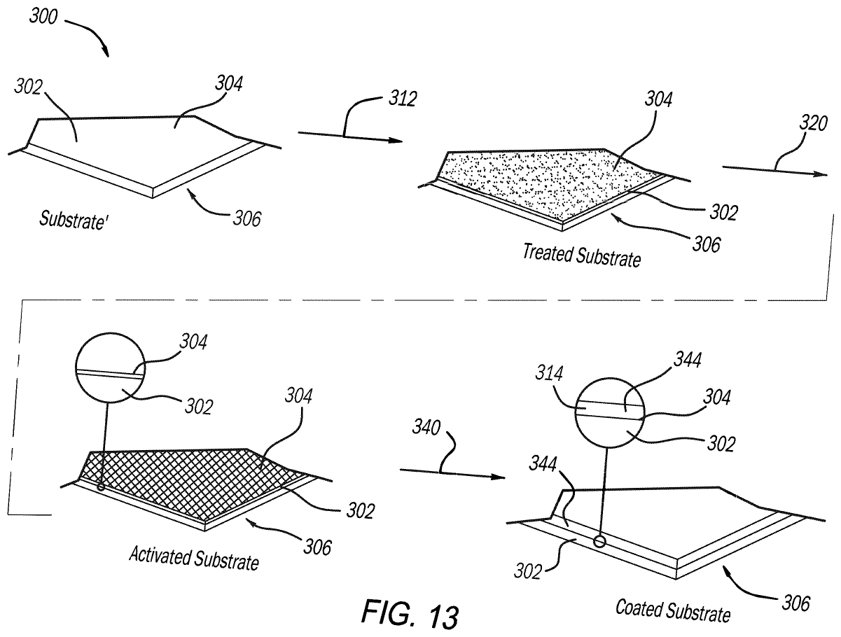

The current collector 40 includes an elongated body 42 extending between a first end 44 and a second end 46 and extending between a first side 47 and a second side 48. The current collector 40 includes a first metallic layer 52, a second metallic layer 54, and a porous polymeric layer 56 disposed between the first metallic layer 52 and the second metallic layer 54. As will be described in greater detail below in the discussion accompanying FIGS. 12 and 13, the porous polymeric layer 56 is configured to be a substrate and the first metallic layer 52 and the second metallic layer 54 are deposited thereon (e.g., by electroless deposition) while metallic particles 62 are deposited therein. It should be appreciated that while only three layers are shown in the embodiment of FIGS. 2 and 3, more or less layers of the metallic and/or porous polymeric material may be included to achieve the desired lightweight, mechanical, chemical, and thermal characteristics of the current collector 40.

The first and second metallic layers 52 and 54 include an electrically conductive metal material. The first and second metallic layers 52 and 54 are selected from the group consisting of: copper, aluminum, nickel, stainless steel, titanium, iron, gold, silver, zinc, alloys thereof, and/or combinations thereof. In one example, each of the first and second metallic layers 52 and 54 include copper, such as when the current collector 40 is configured to be a negative electrode current collector. In another example, each of the first and second metallic layers 52 and 54 include aluminum, such as when the current collector 40 is configured to be a positive electrode current collector.

Each of the first and second metallic layers 52 and 54 has a first average thickness 58 that is about 1 nm to about 5 μm. Preferably, the first average thickness 58 is less than or equal to about 500 nm, such as less than or equal to about 450 nm, optionally less than or equal to about 400 nm, optionally less than or equal to about 350 nm, optionally less than or equal to about 300 nm, optionally less than or equal to about 250 nm, optionally less than or equal to about 200 nm, optionally less than or equal to about 150 nm, optionally less than or equal to about 100 nm, optionally less than or equal to about 50 nm, optionally less than or equal to about 25 nm, or optionally less than or equal to about 10 nm. The first average thickness 58 is greater than or equal to about 1 nm, such as greater than or equal to about 10 nm, optionally greater than or equal to about 25 nm, optionally greater than or equal to about 50 nm, optionally greater than or equal to about 100 nm, optionally greater than or equal to about 150 nm, optionally greater than or equal to about 200 nm, optionally greater than or equal to about 250 nm, optionally greater than or equal to about 300 nm, optionally greater than or equal to about 350 nm, optionally greater than or equal to about 400 nm, or optionally greater than or equal to about 450 nm.

The first and second metallic layers 52 and 54 are coated onto the porous polymeric layer 56, as will be described in greater detail below in the discussion accompanying FIGS. 12 and 13. The first and second metallic layers 52 and 54 may coat all or a portion of the porous polymeric layer 56. The first average thickness 58 may be tailored by tailoring the duration of the coating during fabrication (e.g., a current collector fabricated with a longer coating time will have a larger first average thickness as compared to a current collector fabricated with a shorter coating time).

The porous polymeric layer 56 includes a porous polymer material. The polymeric material for the porous polymer layer 56 is selected form the group consisting of: polyethylene (PE), polypropylene (PP), polydimethylsiloxane (PDMS), poly(methyl methacrylate) (PMMA), polycarbonate (PC), polystyrene (PS), polycaprolactone (PCL), polyimide (PI), polyamide (PA), polyethylene terephthalate (PET), polyvinyl chloride (PVC), polytetrafluoroethylene (PTFE), polyurethane (PU), epoxy resins, co-polymers thereof, and/or combinations thereof. In one example, the porous polymeric layer 56 includes PE, which has a lighter weight compared to other polymers of the same thickness, is relatively low cost, and has desirable mechanical characteristics. The porous polymer material may be a hydrophobic polymer that is treated or modified (e.g., by a plasma) to become hydrophilic. For example, as will be described in greater detail below in the discussion accompanying FIGS. 12 and 13, PE is a hydrophobic polymer that is plasma treated or hydrophilized to enable the coating of a metal material onto the porous polymeric layer 56, such as to form the first and second metallic layers 52 and 54.

As best shown in FIG. 3, the porous polymeric layer 56 includes a plurality of pores 60. Each of the pores 60 has an average diameter that is about 1 nm to about 20 μm. More narrowly, each of the pores 60 may have an average diameter that is about 1 nm to about 5 μm, or 1 nm to 0.1 μm. The pores 60 have a volume density that is about 1 volume percent to about 99 volume percent. For example, the pores 60 may have a volume density that is greater than or equal to about 1 volume percent, optionally greater than or equal to about 5 volume percent, optionally greater than or equal to about 10 volume percent, optionally greater than or equal to about 15 volume percent, optionally greater than or equal to about 20 volume percent, optionally greater than or equal to about 25 volume percent, optionally greater than or equal to about 30 volume percent, optionally greater than or equal to about 35 volume percent, optionally greater than or equal to 40 volume percent, optionally greater than or equal to about 45 volume percent, optionally greater than or equal to about 50 volume percent, optionally greater than or equal to about 55 volume percent, optionally greater than or equal to about 60 volume percent, optionally greater than or equal to about 65 volume percent, optionally greater than or equal to about 70 volume percent, optionally greater than or equal to about 75 volume percent, optionally greater than or equal to about 80 volume percent, optionally greater than or equal to about 85 volume percent, or optionally greater than or equal to about 90 volume percent. The pores 60 may have a volume density that is less than or equal to about 90 volume percent, optionally less than or equal to about 85 volume percent, optionally less than or equal to about 80 volume percent, optionally less than or equal to about 75 volume percent, optionally less than or equal to about 70 volume percent, optionally less than or equal to about 65 volume percent, optionally less than or equal to about 60 volume percent, optionally less than or equal to about 55 volume percent, optionally less than or equal to about 50 volume percent, optionally less than or equal to about 45 volume percent, optionally less than or equal to about 40 volume percent, optionally less than or equal to about 35 volume percent, optionally less than or equal to about 30 volume percent, optionally less than or equal to about 25 volume percent, optionally less than or equal to about 20 volume percent, optionally less than or equal to about 15 volume percent, or optionally less than or equal to about 10 volume percent. More narrowly, the pores 60 may have a volume density that is about 10 volume percent to about 60 volume percent, or a volume density that is about 30 volume percent to about 40 volume percent.

The porous polymeric layer 56 further includes a plurality of metallic particles 62 disposed therein. For example, the metallic particles 62 are disposed in at least some of the pores 60. The metallic particles 62 may be disposed in substantially all of the pores 60. The metallic particles 62 electrically connect the first metallic layer 52 and the second metallic layer 54 such that the current collector 40 is electrically conductive throughout. The metallic particles 62 are nanoparticles, microparticles, or combinations thereof. The metallic particles 62 may be uniformly distributed within the pores 60. Alternately, the metallic particles 62 may be randomly dispersed within the pores 60. The metallic particles 62 are the same material as the first and second metallic layers 52 and 54, respectively. For example, when the first and second metallic layers 52 and 54 are copper, the metallic particles 62 are copper. In another example, when the first and second metallic layers 52 and 54 are aluminum, the metallic particles 62 are aluminum. In yet another example, when the first and second metallic layers 52 and 54 are nickel, the metallic particles 62 are nickel.

The porous polymeric layer 56 has a second average thickness 70 that is about 10 nm to about 200 μm. More narrowly, the second average thickness 70 is about 10 nm to about 25 μm, or about 10 nm to about 5 μm. The second average thickness 70 may be less than or equal to about 200 μm, optionally less than or equal to about 175 μm, optionally less than or equal to about 150 μm, optionally less than or equal to about 125 μm, optionally less than or equal to about 100 μm, optionally less than or equal to about 75 μm, optionally less than or equal to about 50 μm, optionally less than or equal to about 25 μm, optionally less than or equal to about 10 μm, optionally less than or equal to about 5 μm, optionally less than or equal to about 4.5 μm, optionally less than or equal to about 4 μm, optionally less than or equal to about 3.5 μm, optionally less than or equal to about 3 μm, optionally less than or equal to about 2.5 μm, optionally less than or equal to about 2 μm, optionally less than or equal to about 1.5 μm, optionally less than or equal to about 1 μm, or optionally less than or equal to about 500 nm. The second average thickness 70 may be greater than or equal to about 10 nm, optionally greater than or equal to about 500 nm, optionally greater than or equal to about 1 μm, optionally greater than or equal to about 1.5 μm, optionally greater than or equal to about 2 μm, optionally greater than or equal to about 2.5 μm, optionally greater than or equal to about 3 μm, optionally greater than or equal to about 3.5 μm, optionally greater than or equal to about 4 μm, optionally greater than or equal to about 4.5 μm, optionally greater than or equal to about 5 μm, or optionally greater than or equal to about 10 μm, optionally greater than or equal to about 25 μm, optionally greater than or equal to about 50 μm, optionally greater than or equal to about 75 μm, optionally greater than or equal to about 100 μm, optionally greater than or equal to about 125 μm, optionally greater than or equal to about 150 μm, or optionally greater than or equal to about 175 μm.

The current collector 40 has a third average thickness 72. The third average thickness includes the first average thickness 58 of each of the first and second metallic layers 52 and 54, respectively, and the second average thickness 70 of the porous polymeric layer 56. The third average thickness 72 is about 12 nm to about 210 μm. More narrowly, the third average thickness 72 is about 12 nm to about 30 μm. Preferably, the third average thickness 72 is about 12 nm to about 6 μm. The third average thickness 72 may be greater than or equal to about 12 nm, optionally greater than or equal to about 15 nm, optionally greater than or equal to about 50 nm, optionally greater than or equal to about 100 nm, optionally greater than or equal to about 500 nm, optionally greater than or equal to about 1 μm, optionally greater than or equal to about 1.1 μm, optionally greater than or equal to about 1.2 μm, optionally greater than or equal to about 1.5 μm, optionally greater than or equal to about 2 μm, optionally greater than or equal to about 2.5 μm, optionally greater than or equal to about 3 μm, optionally greater than or equal to about 3.5 μm, optionally greater than or equal to about 4 μm, optionally greater than or equal to about 4.5 μm, optionally greater than or equal to about 5 μm, optionally greater than or equal to about 5.5 μm, optionally greater than or equal to about 6 μm, optionally greater than or equal to about 10 μm, optionally greater than or equal to about 20 μm, optionally greater than or equal to about 25 μm, optionally greater than or equal to about 50 μm, optionally greater than or equal to about 75 μm, optionally greater than or equal to about 100 μm, optionally greater than or equal to about 125 μm, optionally greater than or equal to about 150 μm, optionally greater than or equal to about 175 μm, or optionally greater than or equal to about 200 μm. The third average thickness 72 may be less than or equal to about 200 μm, optionally less than or equal to about 175 μm, optionally less than or equal to about 150 μm, optionally less than or equal to about 125 μm, optionally less than or equal to about 100 μm, optionally less than or equal to about 75 μm, optionally less than or equal to about 50 μm, optionally less than or equal to about 30 μm, optionally less than or equal to about 25 μm, optionally less than or equal to about 20 μm, optionally less than or equal to about 10 μm, optionally less than or equal to about 6 μm, optionally less than or equal to about 5.5 μm, optionally less than or equal to about 5 μm, optionally less than or equal to about 4.5 μm, optionally less than or equal to about 4 μm, optionally less than or equal to about 3.5 μm, optionally less than or equal to about 3 μm, optionally less than or equal to about 2.5 μm, optionally less than or equal to about 2 μm, optionally less than or equal to about 1.5 μm, optionally less than or equal to about 1.2 μm, optionally less than or equal to about 1.1 μm, optionally less than or equal to about 1 μm, or optionally less than or equal to about 500 nm.

In one example embodiment, the first metallic layer 52, the second metallic layer 54, and the metallic particles 62 are copper. The porous polymeric layer 56 is PE. The average volume percent of pores of the porous polymeric layer 56 is about 38 volume percent. The first average thickness of each of the first and second metallic layers 52 and 54, respectively, is about 500 nm. The second average thickness 70 of the porous polymeric layer is about 5 μm. Furthermore, the third average thickness 72 of the current collector 40 is about 6 μm (e.g., the thickness of the current collector including the first average thickness 58 of the first metallic layer 52, the first average thickness 58 of the second metallic layer 54, and the second average thickness 70 of the porous polymeric layer 56). The current collector 40 has an average specific mass that is about 0.01 mg/cm² to about 5.9 mg/cm². The current collector 40 may be electrically connected to a negative electrode (e.g., the current collector 40 is a negative electrode current collector).

In another example embodiment, the first metallic layer 52, the second metallic layer 54, and the metallic particles 62 are copper. The porous polymeric layer 56 is PP. The first average thickness of each of the first and second metallic layers 52 and 54, respectively, is about 500 nm. The second average thickness 70 of the porous polymeric layer is about 5 μm. Furthermore, the third average thickness 72 of the current collector 40 is about 6 μm (e.g., the thickness of the current collector including the first average thickness 58 of the first metallic layer 52, the first average thickness 58 of the second metallic layer 54, and the second average thickness 70 of the porous polymeric layer 56).

In another example embodiment, the first metallic layer 52, the second metallic layer 54, and the metallic particles 62 are nickel. The porous polymeric layer 56 is PP. The first average thickness of each of the first and second metallic layers 52 and 54, respectively, is about 500 nm. The second average thickness 70 of the porous polymeric layer is about 5 μm. Furthermore, the third average thickness 72 of the current collector 40 is about 6 μm (e.g., the thickness of the current collector including the first average thickness 58 of the first metallic layer 52, the first average thickness 58 of the second metallic layer 54, and the second average thickness 70 of the porous polymeric layer 56). The current collector 40 has an average specific mass that is about 0.01 mg/cm² to about 5.6 mg/cm².

In yet another example embodiment, the first metallic layer 52, the second metallic layer 54 and the metallic particles 62 are aluminum. The porous polymeric layer 56 is PE. The average volume percent of pores of the porous polymeric layer 56 is about 38 volume percent. The first average thickness of each of the first and second metallic layers 52 and 54, respectively, is about 500 nm. The second average thickness 70 of the porous polymeric layer is about 5 μm. Furthermore, the third average thickness 72 of the current collector 40 is about 6 μm (e.g., the thickness of the current collector including the first average thickness 58 of the first metallic layer 52, the first average thickness 58 of the second metallic layer 54, and the second average thickness 70 of the porous polymeric layer 56). The current collector 40 has an average specific mass that is about 0.01 mg/cm² to about 3.0 mg/cm².

The current collector 40 is thin and lightweight while achieving the desired mechanical, chemical and thermal characteristics. The thickness of the first and second metallic layers 52 and 54, respectively, as well as the other mechanical, chemical and thermal characteristics of the current collector 40 may be tailored based on the duration of coating during fabrication.

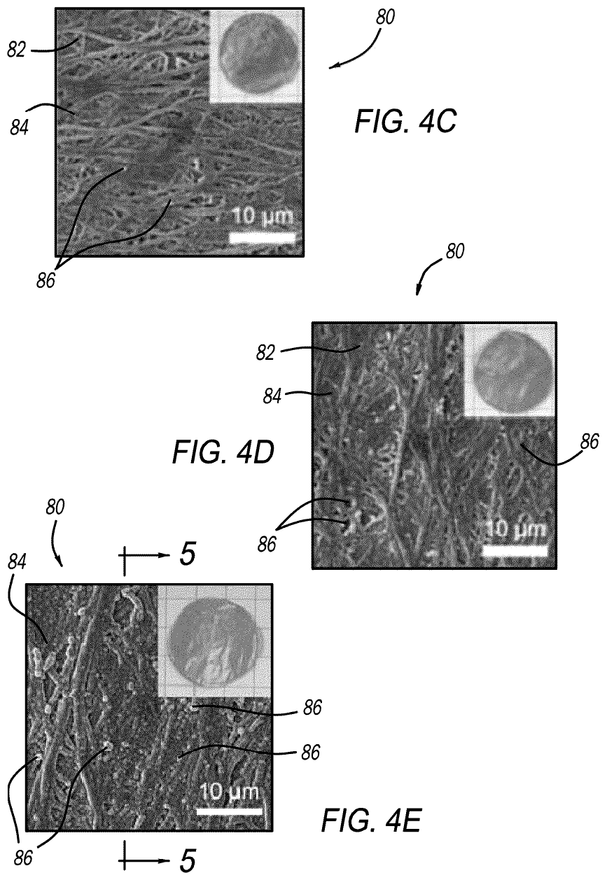

Referring to FIGS. 4A-4E, SEM photographs of a portion of a current collector 80 are shown at various coating durations. The current collector 80 may be the same as the current collector 40 of FIGS. 2 and 3 unless otherwise described below. FIG. 4A shows a portion of a surface 82 of a porous polymeric layer or substrate 84. Similarly, the porous polymeric layer 84 is the same as the porous polymeric layer 56 of FIGS. 2 and 3 unless otherwise described below. The porous polymeric layer 84 is PE. In FIG. 4A, the porous polymeric layer 84 has not yet been coated with a metallic material.

The porous polymeric layer 84 is immersed in a solution including a metallic material 86 (e.g., a metallic ion material), a metallic alloy thereof or a metallic salt thereof. The metallic material 86 is configured to form a layer on (i.e., coat) the porous polymeric layer 84. For example, the metallic material 86 is copper(II) sulfate pentahydrate (CuSO₄) and is configured to form at least one layer of copper on the porous polymeric layer 84. FIG. 4B shows the portion of the porous polymeric layer 84 at a coating duration of 30 seconds. A first concentration of the metallic material 86 is positioned on the surface 82 of the porous polymeric layer 84.

FIG. 4C shows the portion of the porous polymeric layer 84 at a coating duration of 60 seconds. A second concentration of the metallic material 86 is positioned on the surface 82 of the porous polymeric layer 84. The second concentration of the metallic material 86 is greater than the first concentration of the metallic material 86.

FIG. 4D shows the portion of the porous polymeric layer 84 at a coating duration of 90 seconds. A third concentration of the metallic material 86 is positioned on the surface 82 of the porous polymeric layer 84. The third concentration of the metallic material 86 is greater than the second concentration of the metallic material 86.

FIG. 4E shows the portion of the porous polymeric layer 84 at a coating duration of 120 seconds. A fourth concentration of the metallic material 86 is positioned on the surface 82 of the porous polymeric layer 84. The fourth concentration of the metallic material 86 is greater than the third concentration of the metallic material 86. Accordingly, increasing the duration of coating (i.e., the length of time that the porous polymeric layer 84 is immersed in the solution including the metallic material 86) increases the concentration of metallic particles disposed thereon and thereby increases the thickness of the metal layers (e.g., the first and second metallic layer 52 and 54 of FIGS. 2 and 3). Notably, at a coating duration of 120 seconds, the current collector 80 exhibits a surface roughness and texture that is comparable to a copper foil current collector.

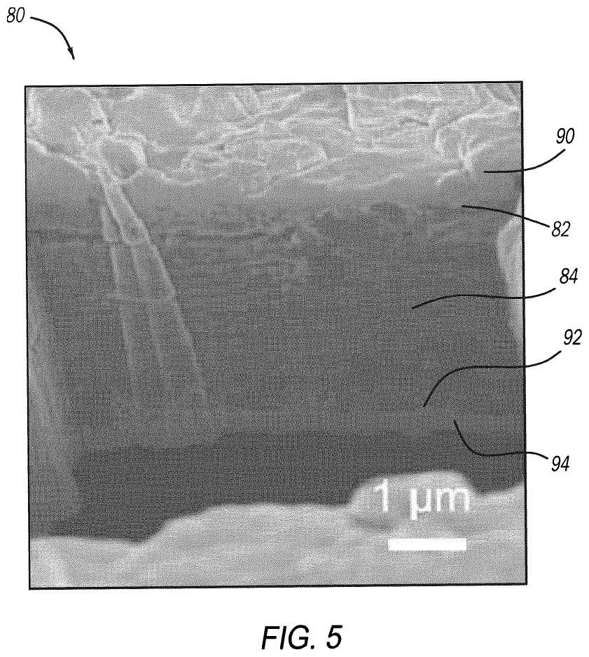

With reference to FIG. 5, the current collector 80 includes a first metallic layer 90 located on the first surface 82 of the porous polymeric layer 84. The current collector 80 further includes a second metallic layer 94 located on a second or bottom surface 92 of the porous polymeric layer 84.

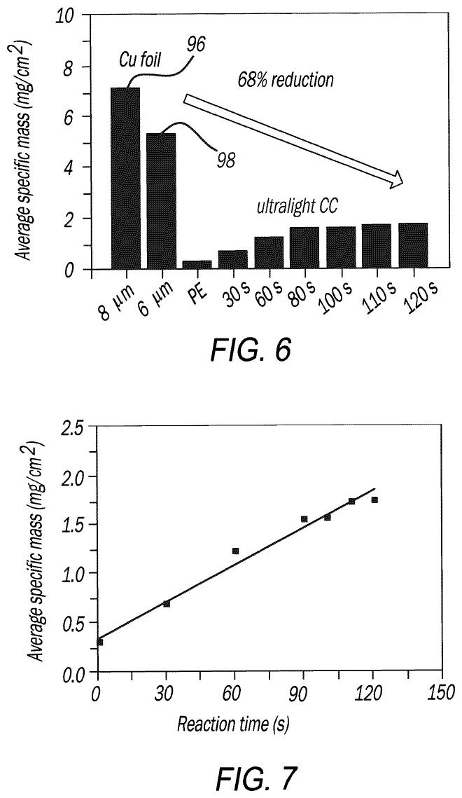

The current collector 80 has an average specific mass that is about 0.01 to 5.9 mg/cm². More narrowly, the current collector 80 may have an average specific mass that is about 0.01 mg/cm² to 2.0 mg/cm². Referring to FIG. 6, the specific mass of the current collector 80 (FIGS. 4A-4E) as compared to copper foil current collectors is shown. A first copper foil current collector 96 having a thickness of 8 μm has a specific mass of about 7.16 mg/cm². A second copper foil current collector 98 having a thickness of about 6 μm has a specific mass of about 5.37 mg/cm². It can be appreciated that the specific mass of the current collector 80 is significantly less than the specific mass of either the first or second copper foil current collectors 96 and 98, respectively. In one example, after a coating duration of 120 seconds, the current collector 80 has a specific mass of about 1.72 mg/cm². The specific mass of the current collector 80 is about 30% of the specific mass of the second copper foil current collector 98. In other words, the current collector 80 has a specific mass that is about 68% less than second copper current collector 98.

FIG. 7 is another graph showing the average specific mass of the current collector 80 (FIGS. 4A-4E) as a function of reaction time, or the time exposed to and/or coated with the metallic material 86 during fabrication. As the reaction time increases, the concentration and/or thickness of metallic material 86 disposed on the surface 82 of the porous polymer substrate 84 increases. Therefore, as the thickness of the metallic material 86 increases, the specific weight of the current collector 80 likewise increases.

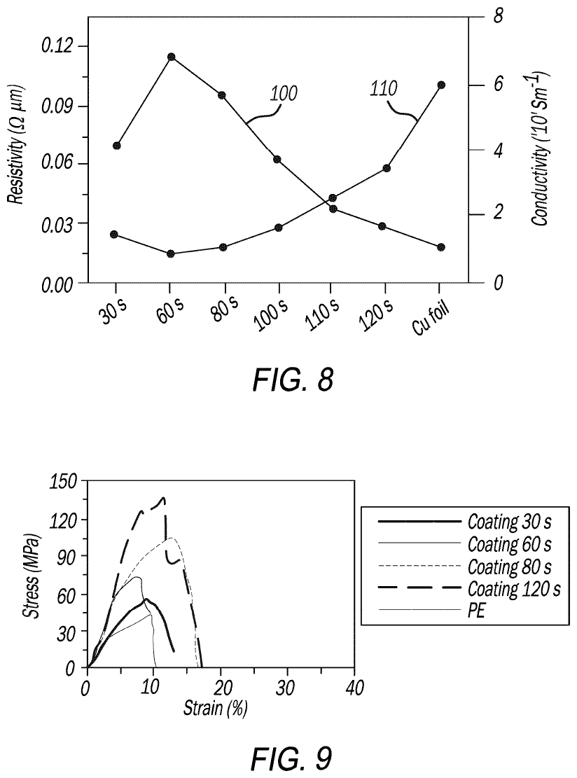

The current collector 80 has a conductivity that is 1×10⁷ S m⁻¹ to about 6×10⁷ at about 20 degrees Celsius. The conductivity may be greater than or equal to about 1×10⁷ S m⁻¹, optionally greater than or equal to about 1.5×10⁷ S m⁻¹, optionally greater than or equal to about 2×10⁷ S m⁻¹, optionally greater than or equal to about 2.5×10⁷ S m⁻¹, optionally greater than or equal to about 3×10⁷ S m⁻¹, optionally greater than or equal to about 3.5×10⁷ S m⁻¹, optionally greater than or equal to about 4×10⁷ S m⁻¹, optionally greater than or equal to about 4.5×10⁷ S m⁻¹, optionally greater than or equal to about 5×10⁷ S m⁻¹, or optionally greater than or equal to about 5.5×10⁷ S m⁻¹. FIG. 8 is a graph showing the resistivity 100 and the conductivity 110 of the current collector 80 (FIG. 4A-4E) at varied coating durations as compared to a copper foil current collector. The conductivity of the current collector 80 increases as the coating duration increases. Notably, after 120 seconds of coating, the current collector 80 achieved a high conductivity of 3.45×10⁷ S m⁻¹. The high conductivity of the current collector 80 is comparable to the copper foil current collector exhibiting a conductivity of 5.97×10⁷ S m⁻¹ at 116.

The current collector 80 has a tensile strength that is about 50 MPa to about 500 MPa. Preferably, the current collector 80 has a tensile strength about 100 MPa to about 400 MPa. FIG. 9 shows the tensile strength of the current collector 80 at varied coating times. Notably, after 120 seconds of coating, the current collector 80 (FIGS. 4A-4E) has a tensile strength of about 120 MPa, which is at the same magnitude as and comparable to the copper foil current collector (e.g., a copper foil current collector having a tensile strength of about 330 MPa).

The current collector 80 has a tensile strain that is about 5% to about 30%. Referring again to FIG. 9, the tensile strain of the current collector 80 at varied coating times is shown. After 120 seconds of coating, the current collector 80 (FIGS. 4A-4E) exhibits a tensile strain of about 15%, which is higher than the tensile strain of a copper foil current collector having a tensile strain of about 5.5 %.

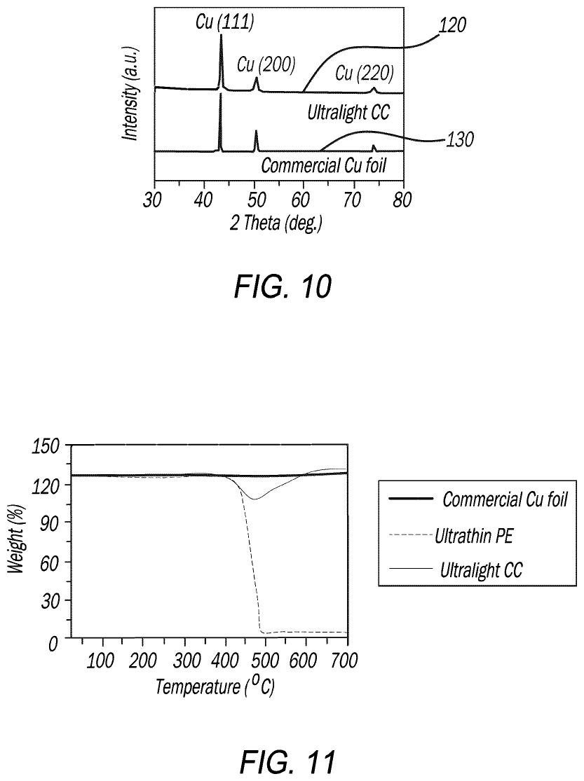

Referring to FIG. 10, X-ray diffraction (XRD) analyses of the present current collector 80 at 120 and a copper foil current collector at 130, are shown. Pure metallic phase copper (111), copper (200), and copper (220) peaks are present for both the current collector 80 (FIGS. 4A-4E) and the copper foil current collector.

The current collector 80 (FIGS. 4A-4E) has excellent thermal characteristics, such as good thermal stability, which has a lower risk of heat dissipation in battery applications as compared to a current collector having poor thermal stability. Preferably, the current collector withstands the operating temperature of the electrochemical cell such that the current collector does not ignite during normal battery operation. Referring to FIG. 11, thermogravimetric analysis (TGA) of the current collector 80 is shown as compared to the TGA of a copper foil current collector. The current collector 80 does not exhibit weight loss signals at temperatures that are less than 400° C.

Methods of making a current collector apparatus as described below facilitate the preparation of a current collector apparatus having a low specific mass at high production rates. For example, the method may facilitate the preparation of an ultra-thin current collector apparatus (e.g., a current collector having thicknesses less than or equal to about 6 μm) having a low specific mass (e.g., having a specific mass that is less than or equal to about 2.0 mg/cm²).

A method 200 of fabricating a current collector for an electrochemical cell is shown in FIG. 12. The method includes optionally treating a surface of a porous polymeric substrate with a plasma at 204; activating the surface of the porous polymeric substrate at 206; preparing a solution including a metallic ion material, a metallic alloy thereof or a metallic salt thereof at 208; coating the porous polymeric substrate with the metallic material, metallic alloy thereof or metallic salt thereof at 210; forming the current collector apparatus at 212; and optionally assembling the current collector apparatus into an electrochemical cell at 214. It can be appreciated that the method may include different steps, additional steps, or a combination of a portion of the steps. Moreover, the steps may be performed in the order described above or in a different order. The steps are described in further detail below.

FIG. 13 shows a schematic illustration of a method 300 of fabricating a current collector apparatus. A porous polymeric substrate 302 includes a first or top surface 304 and a second or bottom surface 306 opposite the first surface 304. The porous polymeric substrate 302 is configured to remain in and/or form the current collector apparatus (e.g., the porous polymeric substrate 302 is configured to form the porous polymeric layer 56 of the current collector 40 of FIGS. 2 and 3).

At 312, the method 300 includes optionally treating one or both surfaces 304 and 306 the porous polymeric substrate 302 with a plasma, such as when the porous polymer substrate 302 comprises a hydrophobic polymer. Preferably, both of the surfaces 304 and 306 are plasma treated. As previously discussed, the porous polymeric substrate 302 may include PE, which is a hydrophobic polymer. It can be appreciated that hydrophobic polymers are resistant to water while hydrophilic polymers are water wettable. It is advantageous to hydrophilize a hydrophobic polymer (i.e., transform the surface of the polymer from hydrophobic to hydrophilic) to coat the substrate 302 with a metallic material via electroless deposition techniques. As will be described in greater detail below, during electroless deposition a metallic material 314 is exposed to the porous polymeric substrate 302 in a water-based or ionic liquid-based solvent (e.g., by immersing the porous polymer substrate 302 in the water-based or ionic liquid-based solvent). Therefore, the porous polymeric substrate 302 must be hydrophilic to enable at least a portion of the metallic material 314 to contact and adhere to the surfaces 304 and 306, respectively. The plasma treatment at 312 modifies the surface chemistry of the surfaces 304 and 306 of the porous polymeric substrate 302 to form hydrophilic surfaces 304 and 306 but does not cause mechanical distortion. While plasma treatment is the preferred method of transforming the surface chemistry of the polymeric substrate 302 from hydrophobic to hydrophilic, alternately other methods such as ultraviolet (UV) irradiation and/or graft polymerization may be used although some of the present benefits may not be realized.

At 320, the method 300 further includes activating or treating one or both of the surfaces 304 and 306 of the porous polymeric substrate 302. Preferably, both of the surfaces 304 and 306 are activated. The activating at 320 increases the adhesion of the metallic material 314 to the surfaces 304 and 306 of the porous polymeric substrate 302. In one example, activating at 320 may include immersing the porous polymeric substrate 302 in a first solution including tin(II) chloride (SnCl₂), palladium(II) chloride (PdCl₂) and hydrochloric acid (HCl). During the immersing, the first solution contacts and chemically activates the surfaces 304 and 306, respectively. The porous polymeric substrate 302 then is ready for coating with the metallic material 314.

The method 300 further includes preparing a second solution including the metallic material 314, a metallic alloy thereof or a metallic salt thereof. In one example, such as when the first metallic layer, the second metallic layer, and the metallic particles include copper, the metallic material 314 is CuSO₄ and the second solution includes CuSO₄, sodium hydroxide (NaOH), ethylenediaminetetraacetic acid disodium salt (EDTA₂Na), and a formaldehyde solution (e.g., including 36.5-38.0% formaldehyde in H₂O). In another example, such as when the first metallic layer, the second metallic layer and the metallic particles include aluminum, the second solution includes AlCl₃-1-ethyl-3-methylimidazolium chloride (AlCl₃-EMIC) and diisobutyl aluminum hydride (DIBAH). In another example, such as when the first metallic layer, the second metallic layer and the metallic particles include nickel, the second solution includes nickel sulfate (NiSO₄·6H2O), sodium citrate (C₆H₅Na₃O₇·2H₂O), boric acid (H₃BO₃), sodium hypophosphite (Na₂H₂PO₂·H₂O) and sodium hydroxide solution (NaOH).

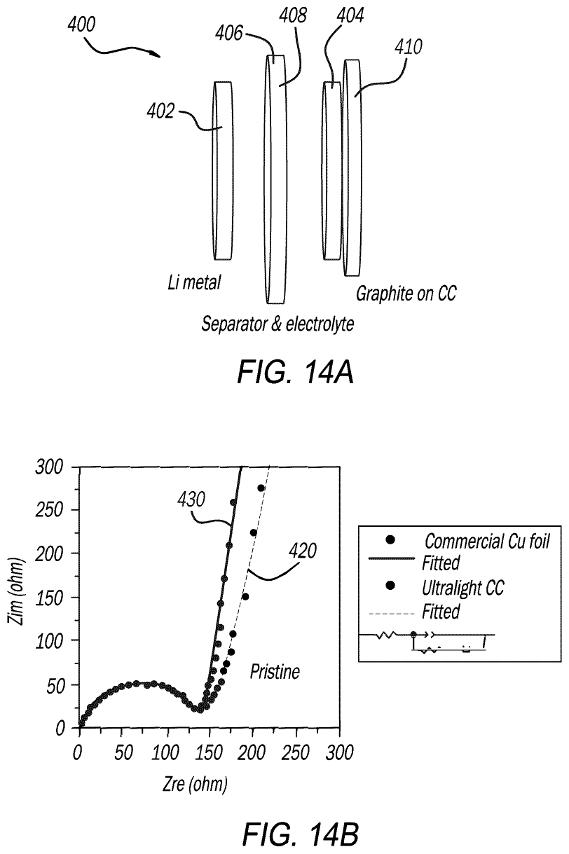

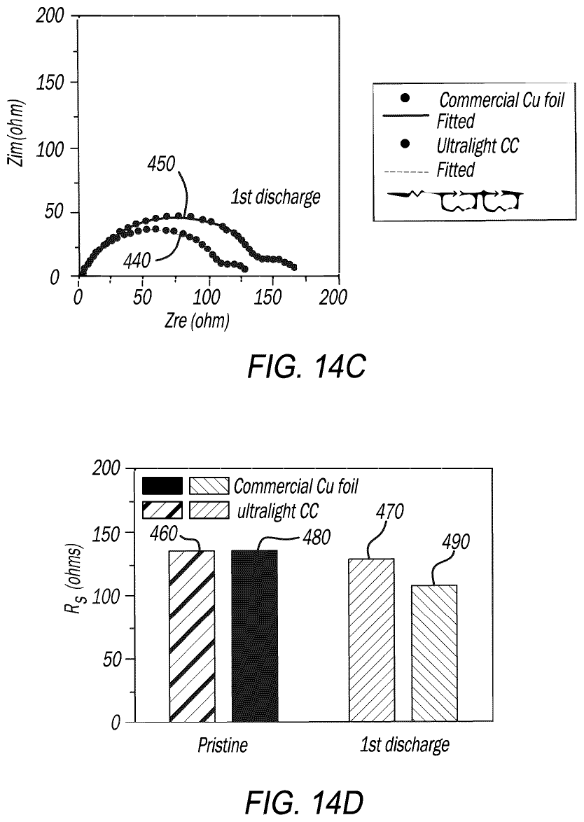

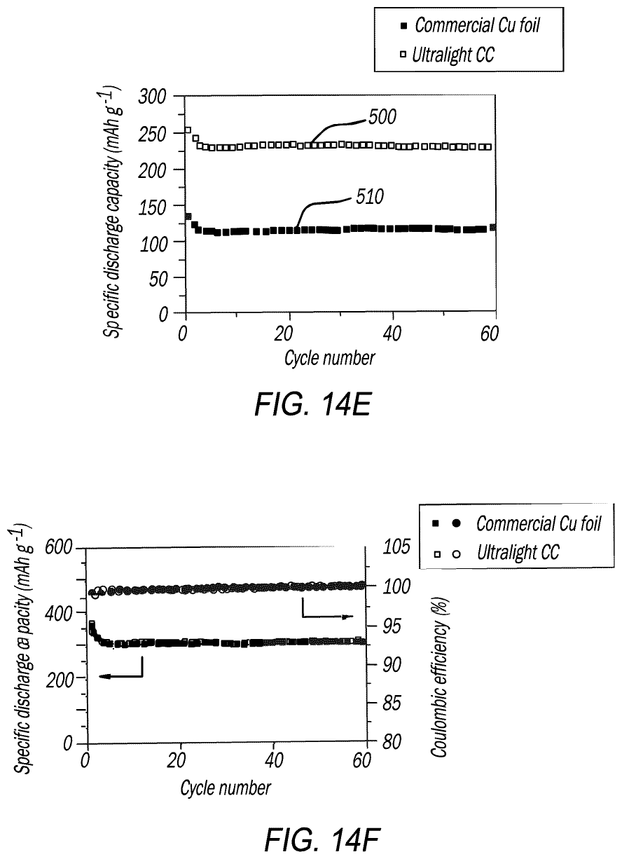

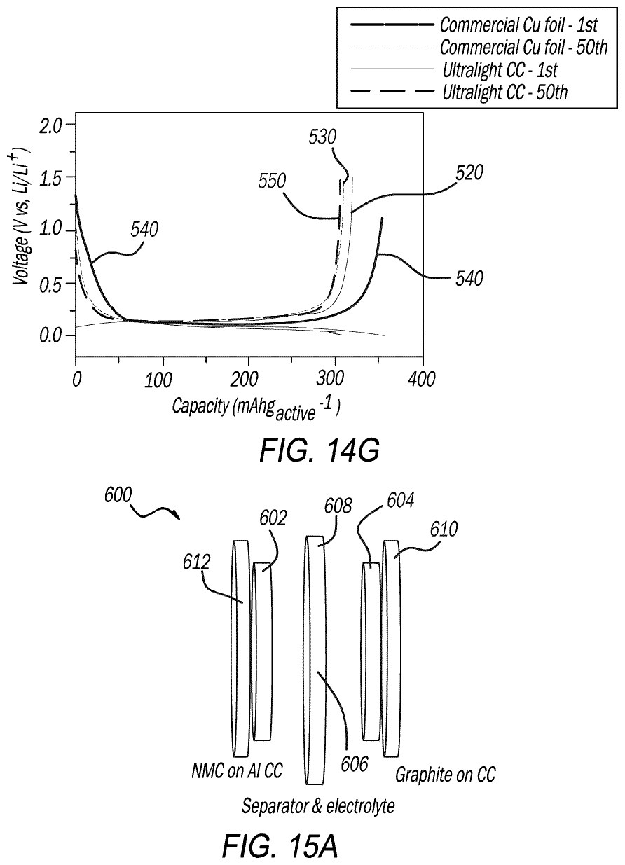

Atb 340, the method 300 includes coating 340 one or both of the surfaces 304 and 306 of the porous polymeric substrate 302 with the metallic material 314, metallic alloy thereof or metallic salt thereof. Although only the first surface 302 is shown as being coated with the metallic material 314 in FIG. 14, preferably, both of the surfaces 304 and 306 are coated. The coating at 340 includes immersing the porous polymeric substrate 302 in the second solution. The metallic material 314 in the second solution contacts one or both of the surfaces 304 and 306, respectively, of the porous polymeric substrate 302. More specifically, the metallic material 314 is deposited onto one or both of the surfaces 304 and 306. Preferably, the metallic material 314 is deposited onto one or both of the surfaces 304 and 306 via electroless deposition. Electroless deposition techniques function to coat a substrate with an electrically conductive metal by immersing the substrate into an aqueous solution including the metallic material (i.e., a solution including the metal ion or salt) without applying an external electrical current and/or potential.

During the coating at 320, a first portion of the metallic material 314 in the second solution contacts and adheres to one or both of the surfaces 304 and 306, forming a first metallic layer 344 on the first surface 304 and a second metallic layer (not shown) on the second surface 306 (see, e.g., the second metallic layer 54 of FIGS. 2 and 3). A second portion of the metallic material 314 infiltrates through the surfaces 304 and 306 of the porous polymeric substrate 302. The second portion of the metallic material 314 is disposed within at least some of the pores of the porous polymeric substrate 302, thus electrically connecting the first metallic layer 344 and the second metallic layer. In one example, when the metallic material 314 includes CuSO₄, the first metallic layer 344 and the second metallic layer are copper, and copper particles are disposed within at least some of the pores of the porous polymer substrate 302.

The coated polymeric substate is then removed from the second solution and cleaned. For example, the coated polymeric substrate may be rinsed with deionized water and a HCl solution. Here, a current collector apparatus is formed.

The method optionally includes assembling the current collector apparatus into an electrochemical cell. For example, the electrochemical cell 10 of FIG. 1 may include the present current collector apparatus as the negative electrode current collector (e.g., negative electrode current collector 22 of FIG. 1) and/or as the positive electrode current collector (e.g., positive electrode current collector 20 of FIG. 1), although other electrochemical cell configurations are possible. The electrochemical cell may be used, for example, in automotive vehicles (e.g., electric vehicles), portable electronic devices (e.g., consumer electronic device, appliance device, medical device, etc.), stationary and/or commercial batteries, and/or electrical planes and aviation devices.

### EXAMPLES

Materials and chemicals: Copper(II) sulfate pentahydrate (for example, and not limitation, an ACS reagent, ≥98.0% from Sigma-Aldrich), ethylenediaminetetraacetic acid disodium salt (EDTA₂Na) dihydrate (for example, and not limitation, an ACS reagent, 99.0-101.0% from Sigma-Aldrich), formaldehyde solution (for example, and not limitation, 36.5-38% in H₂O from Sigma-Aldrich), sodium hydroxide (for example, and not limitation, from Sigma-Aldrich), palladium(II) chloride (PdCl₂) (for example, and not limitation, from Sigma-Aldrich), and tin(II) chloride (SnCl₂) (for example, and not limitation, from Sigma-Aldrich).

Preparation of ultralight current collector: The ultrathin PE (5 μm thickness) is first cleaned with ethanol under sonication and then activated in the solution containing SnCl₂ and PdCl₂ in HCl solution, respectively. The activated PE is then immersed in a mixture of CuSO₄, NaOH, EDTA₂Na, and formaldehyde solution. The temperature is fixed at 55 degrees Celsius during the coating process. After a curtain reaction time, the ultralight current collector with a uniform copper layer on the PE substrate is lifted out of the solution and rinsed with deionized water and a 1.0 M HCl solution. The ultralight current collector is dried and stored under inert atmosphere before use.

Electrochemical Measurements: Cathode sheets are purchased, for example, and not limitation, from from NEI corp. Mesocarbon microbeads (MCMB) graphite powder is obtained, for example, and not limitation, from MTI. The mass ratio of MCMB, PVdf, and conductive super P carbon is 90:5:5. The slurry is casted on the ultralight current collector. The active mass loading is about 12.5 mg/cm² with density loading of about 1.78 g/cm³. The electrolyte used for half and full lithium-ion battery is, for example, and not limitation, 1.0 M LiPF₆ FEC/DMC (1:4 by volume) and 4.0 M LiFSI DME for anode-free cells. The electrolytes are fixed at 50 μL. The cycling performance is recorded on, for example, and not limitation, a Neware battery cycler. The impedance tests of the half cells are performed on, for example, and not limitation, a Princeton PARSTAT MC electrochemical workstation. A 10 mV perturbation voltage with 1 MHz-0.1 Hz frequency range is used. EIS fitting was conducted for example, and not limitation, with Z-view software with curtain equivalent circuit fitting.

### Half-Cell Assembly and Results

FIG. 14A is an exploded perspective view of an exemplary first half-cell assembly 400. The first half-cell assembly 400 includes a positive electrode 402 including lithium metal, a negative electrode 404 including graphite, a separator 406, and an electrolyte 408. The separator 406 and the electrolyte 408 are positioned between the positive electrode 402 and the negative electrode 404. The first half-cell assembly 400 further includes a negative electrode current collector 410 located adjacent to the negative electrode 404. The negative electrode current collector 410 is the same as the current collector 40 of FIGS. 2 and 3, and 80 of FIGS. 4-11, unless otherwise described below. The current collector 410 is formed or manufactured using the methods described in FIGS. 12 and 13, unless otherwise described below. A second half-cell assembly is similarly prepared; however, the second half-cell assembly includes a copper foil current collector.

Referring to FIGS. 14B and 14C, electrochemical impedance spectroscopy (EIS) of the first half-cell assembly 400 (“ultralight CC”) and the second half-cell assembly (“commercial Cu foil”) are shown. FIG. 14B is the first half-cell assembly 400 at 420 and the second-half cell assembly at 430 in a pristine state. FIG. 14C is the first half-cell assembly 400 at 440 and the second-half cell assembly at 450 in a first discharged state. Film resistance is obtained by fitting the data points of FIG. 14B and FIG. 14C for the pristine and 1^{st} discharged states, respectively. FIG. 14D shows the film resistance of the first half-cell assembly 400 in a pristine state 460 and in a first discharge state 470. The film resistance of the second half-cell assembly in a pristine state 480 and in a first discharge state 490 are also shown. The film resistance of the first half-cell assembly 400 in both states is similar to the film resistance of the second half-cell assembly. Accordingly, the use of the current collector 410 does not introduce additional impedance to the first half-cell assembly 400 as compared to the conventional copper foil current collector in the second half-cell assembly. Charge transfer resistance also shows that the current collector 410 does not have a negative influence on the charge transfer process of the first half-cell assembly 410.

FIG. 14E shows the cycling performance of the first half-cell assembly 400 at 500 and the second half-cell assembly at 510. The cycling performance demonstrates a significant improvement in specific capacity when using the current collector 410 as compared to the specific capacity of the second half-cell assembly. The specific capacity of the first half-cell assembly 400 is calculated based on the total mass (e.g., the negative electrode 402, separator 406, electrolyte 408, current collector 410, binders, conductive carbon, etc.) of the first half-cell assembly 400. The specific capacity of the second-half cell assembly is likewise calculated based on the total mass of the second half-cell assembly, which is higher than the total mass of the first half-cell assembly. The first half-cell assembly 400 achieves a specific capacity of 233 mAh/g, which is two times higher than the specific capacity of the second half-cell assembly. This improvement is attributed to the greatly reduced mass of the current collector 410.

FIG. 14F shows that the use of the current collector 410 does not compromise the capacity utilization of the active or electrode materials of the first half-cell assembly 400. The first half-cell assembly 400 exhibits a cycling stability that is comparable to the second-half cell assembly.

FIG. 14G shows the voltage profiles of the first half-cell assembly 400 and the second half-cell assembly at their respective 1^{st} and 50^{th} cycles. The voltage profile of the first half-cell assembly 400 indicates that the current collector 410 does not have a negative effect on the electrochemical reactions of the first half-cell assembly 400. However, the first half-cell assembly 400 does exhibit a relatively short cycle life, with a significant decay being observed after 70 cycles. This is attributed to the consumption of electrolyte caused by the reaction with metallic lithium. Disassembling the first half-cell assembly 400 reveals the dryness of the electrolyte due to parasitic reactions between Li and the electrolyte. Upon reassembling the first half-cell assembly 400 with a new Li electrode and replenishing the electrolyte, the capacity of the first half-cell is largely restored, and the obvious cycling decay trend is greatly reduced.

### Lithium-Ion Full-Cell Assembly and Results

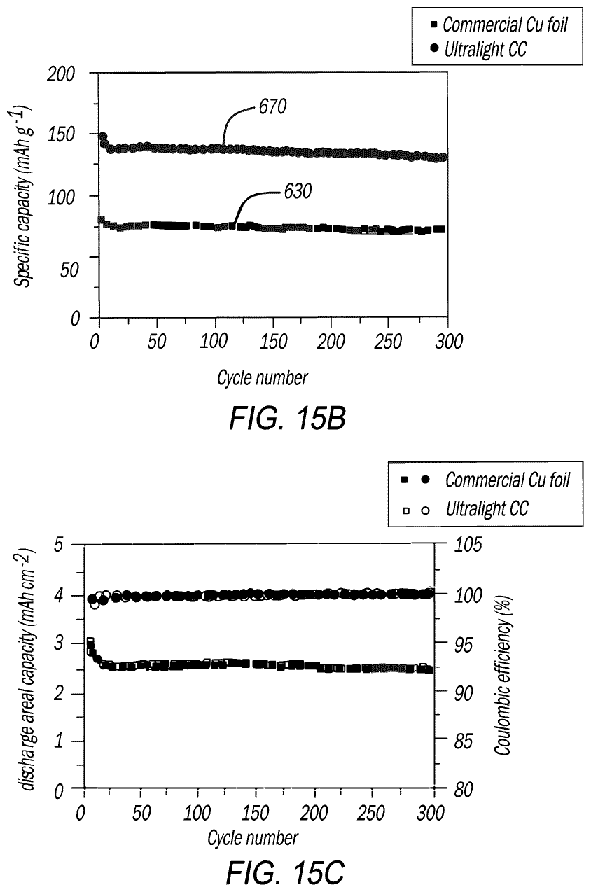

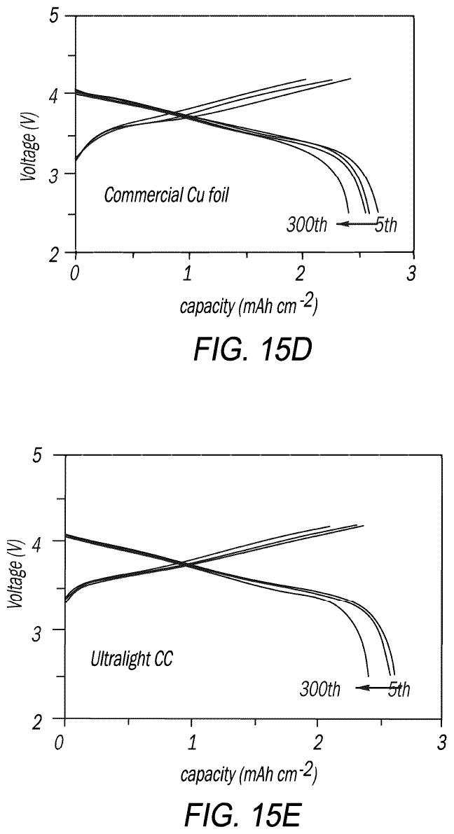

FIG. 15A is an exploded perspective view of an exemplary first lithium-ion full-cell assembly 600. The first full-cell assembly 600 includes a positive electrode 602 including lithium nickel manganese cobalt oxide (NMC), a negative electrode 604 including graphite, a separator 606, and an electrolyte 608. The separator 606 and the electrolyte 608 are positioned between the positive electrode 602 and the negative electrode 604. The first full-cell assembly 600 further includes a negative electrode current collector 610 located adjacent to the negative electrode 604 and a positive electrode current collector 612 located adjacent to the positive electrode 602. The negative electrode current collector 610 may be the same as the current collector 40 of FIGS. 2 and 3, 80 of FIGS. 4-11, and 410 of FIGS. 14A-G, unless otherwise described below. A second full-cell assembly is similarly prepared; however, the second full-cell assembly includes a copper foil current collector.

Once again, the use of the current collector 610 significantly improves the gravimetric specific capacity of the full-cell assembly 600 as compared to the second full-cell assembly including the copper foil current collector. FIG. 15B shows the gravimetric specific capacity of the second full-cell assembly at 630 and the first full-cell assembly 600 at 670. The gravimetric specific capacity of the first full-cell assembly 600 is higher than the gravimetric specific capacity of the second full-cell assembly.

Furthermore, FIG. 15C shows that the areal capacity and Coulombic efficiency (CE) of the respective first full-cell assembly 600 and second full-cell assembly. There is not a significant difference in CE between the current collector 610 of the first full-cell assembly 600 and the copper foil current collector of the second full-cell assembly.

FIGS. 15D and 15E show the voltage profiles of the second full-cell assembly (FIG. 15D) and the first full-cell assembly 600 (FIG. 15E). The voltage profiles exhibit similar shapes, indicating that the current collector 610 did not have negative effect on the electrochemical reactions of the first full-cell assembly 600.

### Lithium-ION “Anode-Free” Cell Assembly and Results

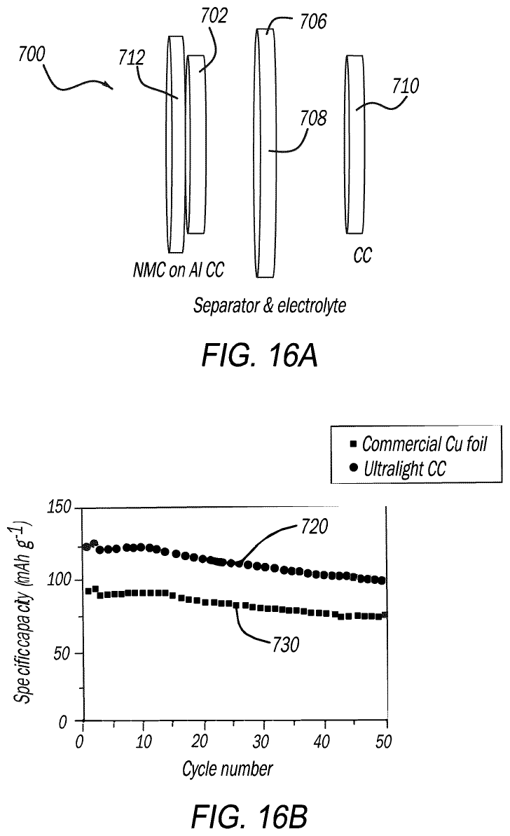

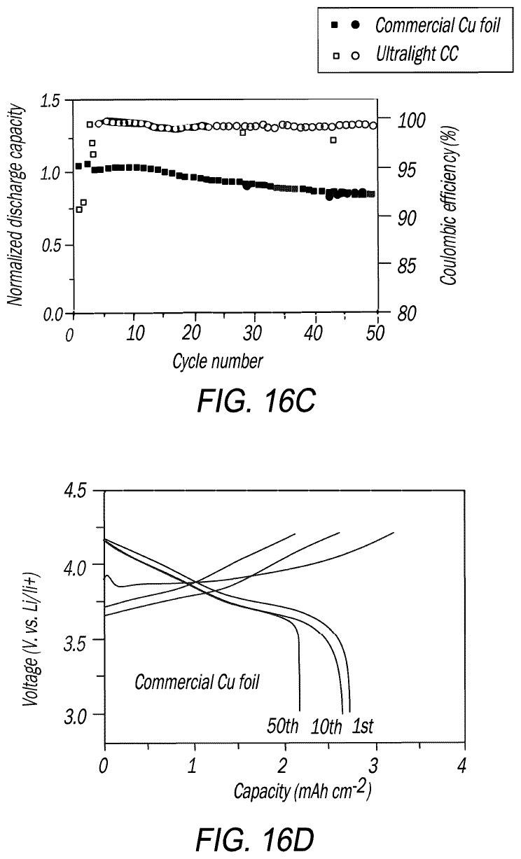

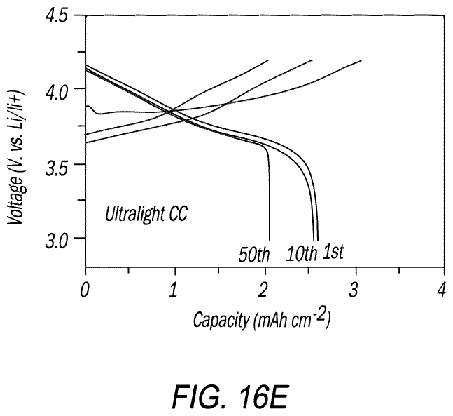

FIG. 16A is an exploded perspective view of an exemplary lithium-ion anode-free cell assembly 700. The anode-free cell assembly 700 includes a positive electrode 702 including NMC, a separator 706, and an electrolyte 708. Notably, the anode-free cell assembly 700 is free of a negative electrode. The anode-free cell assembly 700 further includes a negative electrode current collector 710 and a positive electrode current collector 712 located adjacent to the positive electrode 702. The separator 706 and the electrolyte 708 are positioned between the positive electrode 702 and the negative electrode current collector 710. The negative electrode current collector 710 may be the same as the current collector 40 of FIGS. 2 and 3, 80 of FIGS. 4-11, 410 of FIGS. 14A-G and 610 of FIGS. 15A-E, unless otherwise described below. The anode-free cell assembly 700 has a low mass due to it being free of negative electrode material. A second anode-free cell assembly is similarly prepared; however, the second anode-free cell assembly includes a copper foil current collector.

The use of the current collector 710 significantly improves the gravimetric specific capacity of the anode-free assembly 700 as compared to the second anode-free assembly including the copper foil current collector. FIG. 16B shows the gravimetric specific capacity of the first full-cell assembly 700 at 720 and the second full-cell assembly at 730. The gravimetric specific capacity of the first full-cell assembly 700 is higher than the gravimetric specific capacity of the second full-cell assembly.

Furthermore, FIG. 16C shows that the areal capacity and CE of the respective example anode-free cell assemblies does not show significant differences between the current collector 710 of the first anode-free cell assembly 700 and the copper foil current collector of the second anode-free cell assembly. FIGS. 16D and 16E show the voltage profiles of the second anode-free cell assembly (FIG. 16D) and the first full-cell assembly 700 (FIG. 16E). The voltage profiles exhibit similar shapes, indicating that the current collector 710 did not have negative effect on the electrochemical reactions of the first anode-free cell assembly 700.

### Theoretical Calculations

The lightweight characteristics of the present current collector apparatus reduces mass of an electrochemical cell, thereby promising an enhancement in the overall energy density of the electrochemical cell. Theoretical calculations of cell-level energy density for 50 Ah pouch cells including different current collectors are performed. A first electrochemical cell including a commercial copper foil current collector has a first cell-level energy density of about 287 Wh/kg. A second electrochemical cell including the present current collector apparatus has a second cell-level energy density of about 299 Wh/kg. Accordingly, the present current collector apparatus improves cell-level energy density by at least 4% as compared to the commercial copper foil current collector. It is possible to achieve an overall energy enhancement of existing lithium-ion battery systems to 300 Wh/kg utilizing the present current collector apparatus without pushing the limit of the electrode materials to their extreme.

### Additional Examples

Using the same methods described above, another current collector is prepared using an ultrathin PP substrate (e.g., PP having a thickness of about 5 μm). The current collector includes a first metallic layer comprising copper, a second metallic layer comprising copper, a porous polymer layer comprising PP disposed between the first metallic layer and the second metallic layer. The first metallic layer and the second metallic layer each have a thickness of about 500 nm. Metallic particles comprising copper are disposed in pores of the PP layer, electrically connecting the first metallic layer and the second metallic layer.

Using the same methods described above, another current collector is prepared using an aluminum ion solution and an ultrathin PE substrate (e.g., PE having a thickness of about 5 μm). The activated PE is immersed in solution of AlCl₃-1-ethyl-3-methylimidazolium chloride (AlCl₃-EMIC) ionic liquid with diisobutyl aluminum hydride (DIBAH). The current collector includes a first metallic layer comprising aluminum, a second metallic layer comprising aluminum, and a porous polymer layer comprising PE disposed between the first metallic layer and the second metallic layer. The first metallic layer and the second metallic layer each have a thickness of about 500 nm. Metallic particles comprising aluminum are disposed in pores of the PE layer, electrically connecting the first metallic layer and the second metallic layer.

While various embodiments of the current collector apparatus and method of making thereof have been disclosed, it should be appreciated that other variations may be made. For example, alternate battery configurations, current collector material compositions, and components may be used although some of the present benefits may not be realized. Furthermore, different materials and manufacturing process steps can be used, however, certain of the present benefits may not be achieved. The features of any of the embodiments may be mixed and matched in an interchangeable manner with any of the other embodiments disclosed herein. Various changes and modifications are not to be regarded as a departure from the spirit or the scope of the present invention.

1. A current collector for an electrochemical cell, the current collector comprising:
a first metallic layer;
a second metallic layer;
a porous polymeric layer disposed between the first metallic layer and the second metallic layer, the porous polymeric layer comprising pores and metallic particles disposed in at least some of the pores;
the metallic particles electrically connecting the first metallic layer and the second metallic layer; and
the first metallic layer and the second metallic layer each having a first average thickness that is greater than or equal to about 1 nanometers to less than about 1.5 micrometers.

2. The current collector of claim 1, wherein the first metallic layer, the second metallic layer and the metallic particles comprise aluminum and the porous polymer layer comprises polyethylene (PE), polypropylene (PP), polydimethylsiloxane (PDMS), poly(methyl methacrylate) (PMMA), polycarbonate (PC), polystyrene (PS), polycaprolactone (PCL), polyimide (PI), polyamide (PA), polyethylene terephthalate (PET), polyvinyl chloride (PVC), polytetrafluoroethylene (PTFE), polyurethane (PU), epoxy resins, co-polymers thereof, or combinations thereof.

3. The current collector of claim 1, wherein the first metallic layer, the second metallic layer, and the metallic particles comprise copper and the porous polymer layer comprises polyethylene (PE), polypropylene (PP), polydimethylsiloxane (PDMS), poly(methyl methacrylate) (PMMA), polycarbonate (PC), polystyrene (PS), polycaprolactone (PCL), polyimide (PI), polyamide (PA), polyethylene terephthalate (PET), polyvinyl chloride (PVC), polytetrafluoroethylene (PTFE), polyurethane (PU), epoxy resins, co-polymers thereof, or combinations thereof.

4. The current collector of claim 1, wherein the first metallic layer, the second metallic layer, and the metallic particles comprise nickel and the porous polymer layer comprises polyethylene (PE), polypropylene (PP), polydimethylsiloxane (PDMS), poly(methyl methacrylate) (PMMA), polycarbonate (PC), polystyrene (PS), polycaprolactone (PCL), polyimide (PI), polyamide (PA), polyethylene terephthalate (PET), polyvinyl chloride (PVC), polytetrafluoroethylene (PTFE), polyurethane (PU), epoxy resins, co-polymers thereof, or combinations thereof.

5. The current collector of claim 1, wherein the current collector is configured to be electrically connected to a negative electrode of the electrochemical cell.

6. The current collector of claim 1, wherein the current collector is configured to be electrically connected to a positive electrode of the electrochemical cell.

7. The current collector of claim 1, wherein the first average thickness of the porous polymeric layer is greater than or equal to about 1 nanometer to less than or equal to about 1 micrometer.

8. The current collector of claim 1, wherein a second average thickness of the porous polymeric layer is greater than or equal to about 10 nanometers to less than or equal to about 5 micrometers.

9. The current collector of claim 1, wherein a third average thickness of the current collector is greater than or equal to about 12 nanometers to less than or equal to about 6 micrometers.

10. The current collector of claim 1, wherein the first average thickness is about 500 nanometers, a second average thickness of the porous polymeric layer is about 5 micrometers, and a third average thickness of the current collector is about 6 micrometers.

11. The current collector of claim 1, wherein the first metallic layer and the second metallic layer are selected from the group consisting of: copper, aluminum, nickel, stainless steel, titanium, iron, gold, silver, alloys thereof, or combinations thereof.

12. The current collector of claim 1, wherein the metallic particles comprise the same material as the first metallic layer and the second metallic layer.

13. The current collector of claim 1, wherein the porous polymeric layer is selected from the group consisting of: polyethylene (PE), polypropylene (PP), polydimethylsiloxane (PDMS), poly(methyl methacrylate) (PMMA), polycarbonate (PC), polystyrene (PS), polycaprolactone (PCL), polyimide (PI), polyamide (PA), polyethylene terephthalate (PET), polyvinyl chloride (PVC), polytetrafluoroethylene (PTFE), polyurethane (PU), epoxy resins, co-polymers thereof, or combinations thereof.

14. The current collector of claim 1, wherein:
the first metallic layer, the second metallic layer, and the metallic particles comprise copper, and
the porous polymeric layer comprises polyethylene (PE), polypropylene (PP), co-polymers thereof, or combinations thereof.

15. The current collector of claim 1, wherein the pores of the porous polymer layer have an average diameter that is greater than or equal to about 1 nanometer to less than or equal to about 20 micrometers.

16. The current collector of claim 1, wherein the pores of the porous polymer layer have a volume density that is greater than or equal to about 1 volume percent to less than or equal to about 99 volume percent.

17. The current collector of claim 1, wherein the current collector has a specific mass that is greater than or equal to about 0.01 mg/cm² to less than or equal to about 5.9 mg/cm².

18. The current collector of claim 1, wherein the current collector is configured for use in an electric vehicle battery, a consumer electronics battery, an appliance battery, or a medical device battery.

19. A current collector for an electrochemical cell, the current collector comprising:
a first metallic layer;
a second metallic layer;
a porous polymeric layer disposed between the first metallic layer and the second metallic layer, the porous polymeric layer comprising pores and metallic particles disposed in at least some of the pores;
the first metallic layer, the second metallic layer, and the metallic particles comprising the same material selected from the group consisting of: copper, aluminum, nickel, stainless steel, titanium, iron, alloys thereof, and combinations thereof;
the metallic particles electrically connecting the first metallic layer and the second metallic layer; and
the current collector having an average thickness that is greater than or equal to about 12 nanometers to less than or equal to about 210 micrometers.

20. The current collector of claim 19, wherein the porous polymeric layer is selected from the group consisting of: polyethylene (PE), polypropylene (PP), polydimethylsiloxane (PDMS), poly(methyl methacrylate) (PMMA), polycarbonate (PC), polystyrene (PS), polycaprolactone (PCL), polyimide (PI), polyamide (PA), polyethylene terephthalate (PET), polyvinyl chloride (PVC), polytetrafluoroethylene (PTFE), polyurethane (PU), epoxy resins, co-polymers thereof, or combinations thereof.

21. The current collector of claim 19, wherein the pores of the porous polymer layer have a volume density that is greater than or equal to about 1 volume percent to less than or equal to about 99 volume percent.

22. The current collector of claim 19, wherein the current collector is configured for use in an electric vehicle battery, a consumer electronics battery, an appliance battery, or a medical device battery.

23. A current collector for an electrochemical cell, the current collector comprising:
a first metallic layer;
a second metallic layer;
a porous polymeric layer located between the first metallic layer and the second metallic layer, the porous polymeric layer comprising metallic particles in at least some pores;
the first metallic layer, the second metallic layer, and the metallic particles comprising the same material including at least one of: copper, aluminum, nickel, stainless steel, titanium, iron, alloys thereof, and combinations thereof;
the metallic particles electrically connecting the first metallic layer and the second metallic layer; and
the first metallic layer and the second metallic layer each having an average thickness that is greater than or equal to 1 nanometer to less than or equal to 5 micrometers.

24. The current collector of claim 23, wherein the porous polymeric layer includes at least one of: polyethylene (PE), polypropylene (PP), polydimethylsiloxane (PDMS), poly(methyl methacrylate) (PMMA), polycarbonate (PC), polystyrene (PS), polycaprolactone (PCL), polyimide (PI), polyamide (PA), polyethylene terephthalate (PET), polyvinyl chloride (PVC), polytetrafluoroethylene (PTFE), polyurethane (PU), epoxy resins, co-polymers thereof, or combinations thereof.

25. The current collector of claim 23, wherein an average thickness of the porous polymeric layer is greater than or equal to 10 nanometers to less than or equal to 5 micrometers.

26. The current collector of claim 23, wherein an average thickness of the current collector is greater than or equal to 12 nanometers to less than or equal to 6 micrometers.

27. The current collector of claim 23, wherein the average thickness of the first metallic layer and the second metallic layer is about 500 nanometers, an average thickness of the porous polymeric layer is about 5 micrometers, and an average thickness of the current collector is about 6 micrometers.

28. The current collector of claim 23, wherein the pores of the porous polymer layer have a volume density that is greater than or equal to 1 volume percent to less than or equal to 99 volume percent.

29. The current collector of claim 23, wherein the current collector has a specific mass that is greater than or equal to 0.01 mg/cm² to less than or equal to 5.9 mg/cm².

30. The current collector of claim 23, wherein the current collector is configured for use in: an electric vehicle battery, a consumer electronics battery, an appliance battery, or a medical device battery.
